(19) United States
(12) Patent Application Publication
(10) Pub. No.: US 2025/0123155 A1
(43) Pub. Date: Apr. 17, 2025

(54) POWER MANAGEMENT FOR BATTERY-OPERATED TEMPERATURE SENSORS

(71) Applicant: Saya Life, Inc., Los Angeles, CA (US)

(72) Inventors: Sanjay Poojary, Irvine, CA (US); Chongliang Li, Irvine, CA (US)

(21) Appl. No.: 18/918,620

(22) Filed: Oct. 17, 2024

Related U.S. Application Data
(60) Provisional application No. 63/591,006, filed on Oct. 17, 2023.

(51) Int. Cl. G01K 7/22; G01K 3/00

(52) U.S. Cl. CPC G01K 7/22; G01K 3/005; G01K 2215/00

(57) ABSTRACT

An energy-efficient battery-operated temperature sensor system including a temperature sensor having an off mode, a low-power mode, and a high-power mode. The temperature sensor in the low-power mode may be configured to sense when an environmental temperature reaches a temperature threshold. The temperature sensor in the high-power mode may be configured to measure the environmental temperature in real-time. The temperature sensor may be shifted into the high-power mode when the environmental temperature reaches the temperature threshold.

### CROSS-REFERENCES TO RELATED APPLICATIONS

This application is a non-provisional and claims benefit of U.S. Patent Application No. 63/591,006, filed Oct. 17, 2023, the specification of which is incorporated herein in its entirety by reference.

### FIELD OF THE INVENTION

The present invention is directed to a detection device consuming less than the discharge current for use in a battery-operated temperature sensor.

### BACKGROUND OF THE INVENTION

In a battery-powered device, especially a small capacity coin battery-powered device, power consumption must be limited as much as possible to extend the battery life, to reduce the times the battery needs to be replaced, or ideally, the battery lasts until the designed life cycle of the device is reached so that no battery replacement is necessary. The battery self-discharge refers to the reduction of battery capacity by internal unwanted chemical reactions. Therefore shelf life is reduced, even when the battery is not used. Consider a lithium-ion polymer battery with a rating of 1000 mAh. The capacity rate, or C-rate, designates the rate at which the battery is discharged to its maximum capacity. 1 C means that the battery can provide 1000 mA for one hour until it is completely discharged. Similarly, 0.5 C means that the battery can provide 500 mA of current for two hours until it is discharged.

A very reasonable approximation to discharge a battery of 1000 mAh capacity over a month is approximately 1 (2430) hours=0.001388 C or 1000 m (2430) hours=1.388 mA discharge current. Therefore, a self-discharge of 1% capacity per month is equivalent to 1% of the discharge current of 0.001388 C, which is (1% of 1000 mAh/720 hours)≈14 μA. If the application circuit consumes less than the discharge current, the battery is limited by the shelf life, not the current consumed by the application circuit. Thus, there exists a present need for a circuit consuming less than the discharge current for use in a battery-operated temperature sensor.

### BRIEF SUMMARY OF THE INVENTION

The objective of the present invention is to provide devices that allow for a detection device that consumes less than the discharge current for use in a battery-operated temperature sensor, as specified in the independent claims. Embodiments of the invention are given in the dependent claims. Embodiments of the present invention can be freely combined with each other if they are not mutually exclusive.

In some embodiments, the present invention features an energy-efficient battery-operated temperature sensor system comprising a temperature sensor having an off mode, a low-power mode, and a high-power mode. The temperature sensor in the low-power mode may be configured to sense when an environmental temperature reaches a temperature threshold. The temperature sensor in the high-power mode may be configured to measure the environmental temperature in real-time. In some embodiments, the temperature sensor is shifted into the high-power mode when the environmental temperature reaches the temperature threshold.

One of the unique and inventive technical features of the present invention is the implementation of a negative temperature coefficient thermistor coupled to an accurate temperature sensing circuit configured to shift between an off mode, a low-power mode, and a high-power mode depending on the temperature. Without wishing to limit the invention to any theory or mechanism, it is believed that the technical feature of the present invention advantageously provides for the maximization of battery usage in a small temperature sensor, such that the battery's life is extended to its shelf life instead of being consumed by the current. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic diagram of the temperature sensor of the present invention.

FIG. 1B shows a schematic diagram of the battery-operated temperature-sensing system of the present invention.

FIG. 1C shows a flow chart of a method for maximizing the power efficiency of the battery-operated temperature-sensing system of the present invention.

### DETAILED DESCRIPTION OF THE INVENTION

Following is a list of elements corresponding to a particular element referred to herein:
100 system
110 temperature sensor
120 battery
130 negative temperature coefficient (NTC) thermistor
140 microcontroller unit (MCU)

The term “environmental temperature” is defined herein as the temperature of an area surrounding an object.

The term “discharge current” is defined herein as the electrical energy emitted by a battery in a circuit.

The term “negative temperature coefficient thermistor” is defined herein as a resistor with a negative temperature coefficient, which means that the resistance decreases with increasing temperature.

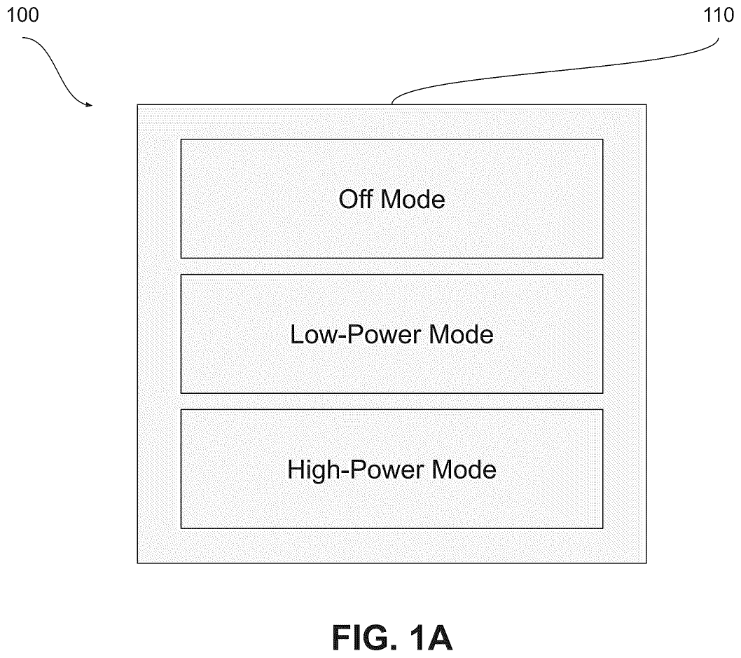

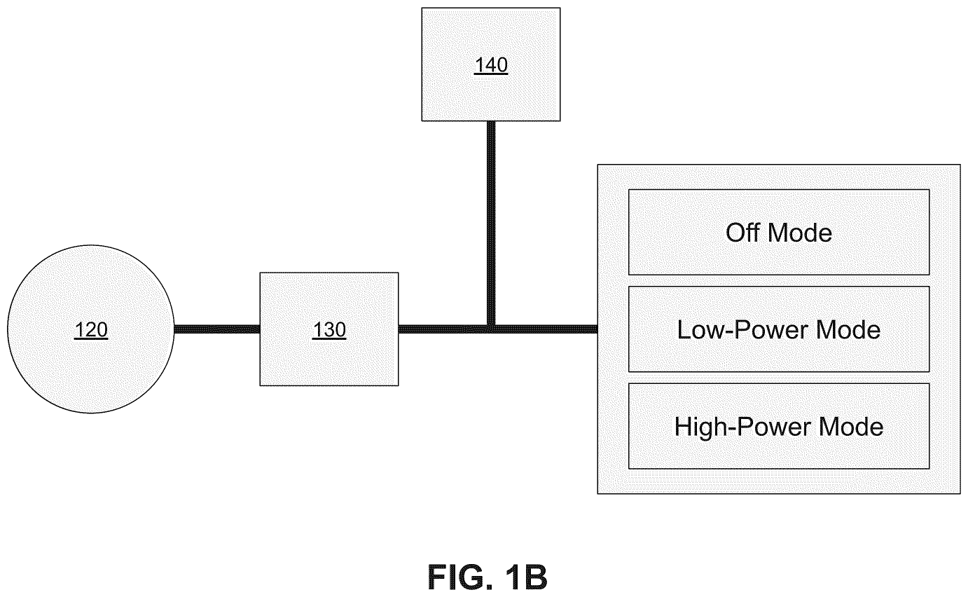

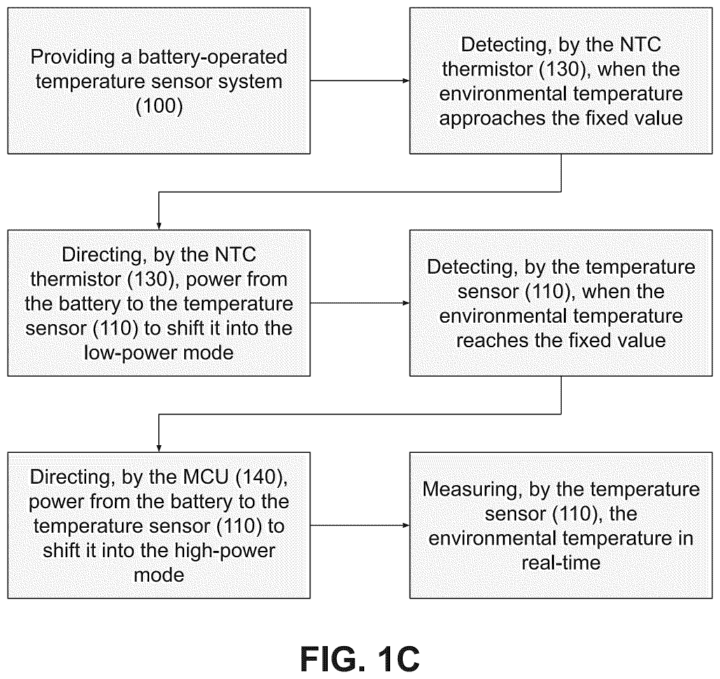

Referring now to FIG. 1A, the present invention features an energy-efficient battery-operated temperature sensor system (100). In some embodiments, the system (100) may comprise a temperature sensor (110) having an off mode, a low-power mode, and a high-power mode. The temperature sensor (110) in the low-power mode may be configured to sense when an environmental temperature reaches a temperature threshold. The temperature sensor (110) in the high-power mode may be configured to measure the environmental temperature in real-time. When the environmental temperature reaches the temperature threshold, the temperature sensor (110) may be shifted into the high-power mode.

In some embodiments, the system (100) may further comprise a battery (120) operatively coupled to the temperature sensor (110). In some embodiments, the temperature sensor (110) may be configured to consume less than or equal to the average discharge current of the battery (120). In some embodiments, the system (100) may further comprise a negative temperature coefficient (NTC) thermistor (130) operatively coupled to the battery (120) and the temperature sensor (110), having a resistance inversely proportional to temperature, configured to control power delivered from the battery (120) to the temperature sensor (110) such that the NTC thermistor (130) shifts the temperature sensor (110) from the off mode to the low-power mode when the environmental temperature approaches the temperature threshold.

In some embodiments, the system (100) may further comprise a microcontroller unit (MCU) (140) operatively coupled to the battery (120) and the temperature sensor (110) configured to shift the temperature sensor (110) from the low-power mode to the high-power mode when the environmental temperature reaches the temperature threshold. In some embodiments, the MCU (140) may be further configured to transmit an alert to an external source when the temperature sensor (110) detects that the environmental temperature reaches the temperature threshold. In some embodiments, the temperature threshold may be 0 degrees Celsius. In some embodiments, the temperature threshold may be 0 to 10 degrees Celsius.

Referring now to FIG. 1B, the present invention features an energy-efficient battery-operated temperature sensor system (100). In some embodiments, the system (100) may comprise a battery (120). The system (100) may further comprise a temperature sensor (110) operatively coupled to the battery (120), having an off mode, a low-power mode, and a high-power mode. The temperature sensor (110) in the low-power mode may be configured to sense when an environmental temperature reaches a temperature threshold. The temperature sensor (110) in the high-power mode may be configured to measure the environmental temperature in real-time. The system (100) may further comprise a negative temperature coefficient (NTC) thermistor (130) operatively coupled to the battery (120) and the temperature sensor (110), having a resistance inversely proportional to temperature, configured to control power delivered from the battery (120) to the temperature sensor (110) such that the NTC thermistor (130) shifts the temperature sensor (110) from the off mode to the low-power mode when the environmental temperature approaches the temperature threshold. The system (100) may further comprise a microcontroller unit (MCU) (140) operatively coupled to the battery (120) and the temperature sensor (110), configured to shift the temperature sensor (110) into the high-power mode when the environmental temperature reaches the temperature threshold.

In some embodiments, the temperature sensor (110) may be configured to consume less than or equal to the average discharge current of the battery (120). In some embodiments, the MCU (140) may be further configured to transmit an alert to an external source when the temperature sensor (110) detects that the environmental temperature reaches the temperature threshold. In some embodiments, the temperature threshold may be 0 degrees Celsius. In some embodiments, the temperature threshold may be 0 to 10 degrees Celsius.

Referring now to FIG. 1C, the present invention features a method for maximizing the energy efficiency of a battery-operated temperature sensor system (100). In some embodiments, the method may comprise providing the system (100). The system (100) may comprise a battery (120). The system (100) may further comprise a temperature sensor (110) operatively coupled to the battery (120), having an off mode, a low-power mode, and a high-power mode. The system (100) may further comprise a negative temperature coefficient (NTC) thermistor (130) operatively coupled to the battery (120) and the temperature sensor (110), having a resistance inversely proportional to temperature. The system (100) may further comprise a microcontroller unit (MCU) (140) operatively coupled to the battery (120) and the temperature sensor (110).

The method may further comprise detecting, by the NTC thermistor (130), when the environmental temperature approaches the temperature threshold. The method may further comprise directing, by the NTC thermistor (130), power from the battery to the temperature sensor (110) such that the temperature sensor (110) is shifted into the low-power mode. The method may further comprise detecting, by the temperature sensor (110) in the low-power mode, when the environmental temperature reaches the temperature threshold. The method may further comprise directing, by the MCU (140), power from the battery to the temperature sensor (110) such that the temperature sensor (110) is shifted into the high-power mode. The method may further comprise measuring, by the temperature sensor (110) in the high-power mode, the environmental temperature in real-time.

In some embodiments, the temperature sensor (110) may be configured to consume less than or equal to the average discharge current of the battery (120). In some embodiments, the method may further comprise transmitting, by the MCU (140), an alert to an external source when the temperature sensor (110) detects that the environmental temperature reaches the temperature threshold. In some embodiments, the temperature threshold may be 0 degrees Celsius. In some embodiments, the temperature threshold may be 0 to 10 degrees Celsius.

This invention provides a method for a “frozen” detection device to run at an average of the battery's discharge current, thus maximizing the battery life close to its limited shelf life. The same method also applies to other temperature ranges other than 0 degrees centigrade (“frozen”). A negative temperature coefficient (NTC) thermistor is a resistor whose resistance is inversely proportional to temperature, and a temperature sensor integrated circuit (IC) provides the functionality to precisely report the temperatures and ability to “wake up” at certain temperature value, but usually at a higher power consumption level.

This method utilizes both NTC and temperature sensor IC to minimize power consumption and maintain measurement accuracy at a certain range. Due to the inaccuracy of the NTC thermistor, other supporting electronic components, and other environmental variables, it is hard or impossible to design a circuit to wake up the MCU at the “right” moment. However, a circuit can be designed to wake up the MCU, when the temperature, in this case, is approaching 0 degrees centigrade. In the following example, the NTC's resistance is about 470KΩ, and the VCC voltage is around 3.2 volts, so the power consumption of this circuit is around 3.2 v/(1.6 MΩ+470 MΩ)≈1.6μ, far below the battery's self-discharge rate.

In one embodiment, the MCU is configured to wake up at logic input 1 (above 1.5 volts) at the temperature sensor's general-purpose input/output (GPIO) pin, in normal conditions the voltage on the temperature sensor is not high enough, so the MCU is maintained in deep sleep mode. When the temperature approaches 0 degrees, the NTC's resistance is increased to around 1.6 MΩ, the voltage on the temperature sensor is increased to above 1.5V, and the MCU wakes up, however, it can not stay awake as it consumes too much power, and it is not certain when the temperature will drop below 0 degrees. The MCU can then configure the temperature sensing IC to continuously monitor the environmental temperature and wake up the MCU again by raising the ALERT pin to logic high when the temperature reaches 0 degrees. So combined, the application circuit can provide accurate temperature monitoring as the temperature approaches the 0-degree range with the power consumption close to the battery's self-discharge rate.

In some embodiments, the temperature threshold may be 0 degrees Celsius. In some embodiments, the temperature threshold may be 0 to 10 degrees Celsius. In some embodiments, the temperature threshold may be 0 to 5 degrees Celsius. In some embodiments, the temperature threshold may be 5 to 10 degrees Celsius. In some embodiments, the temperature threshold may be 5 degrees Celsius to detect when the environmental temperature is approaching freezing.

In some embodiments, the NTC thermistor (130) may shift the temperature sensor (110) from the off mode to the low-power mode when the environmental temperature approaches the temperature threshold. “Approaching” the temperature threshold may comprise coming within a certain number of degrees Celsius of the temperature threshold. For example, if the temperature threshold is 0 degrees Celsius, the environmental temperature may be considered “approaching” the temperature threshold when the environmental temperature reaches 5 degrees Celsius. In some embodiments, approaching the temperature threshold may comprise coming within 5 degrees of the temperature threshold. In some embodiments, approaching the temperature threshold may comprise coming within 1 degree of the temperature threshold. In some embodiments, approaching the temperature threshold may comprise coming within 0.5 to 10 degrees of the temperature threshold.

In some embodiments, the low power mode may comprise a power consumption of 1 to 2 μA. In some embodiments, the high power mode may comprise a power consumption of 5 to 7 mA. In some embodiments, the average discharge current of the battery (120) may comprise 12 to 14 μA. In some embodiments, the battery (120) may comprise an alkaline battery, a lithium battery, a zinc-carbon battery, a nickel-cadmium (NiCd) battery, a nickel-metal hydride (NiMH) battery, a coin and button cell battery, a zinc-air cell battery, a rechargeable battery, or a combination thereof.

In some embodiments, the microcontroller unit (MCU) (140) may comprise a small computer on a single integrated circuit. The MCU (140) may comprise one or more processing cores configured to execute computer-readable instructions. In some embodiments, the MCU (140) may further comprise a memory component operatively coupled to the one or more processing cores, comprising computer-readable instructions for converting the temperature sensor (110) from a low-power mode to a high-power mode, transmitting the alert to the external sources, receiving the temperature measurement from the temperature sensor (110), and transmitting the temperature measurement to the external sources. The MCU (140) may further comprise a random-access memory component to aid in executing the computer-readable instructions. The MCU (140) may comprise an electrical connection to the battery (120) such that the MCU (140) is powered on when the NTC thermistor (130) reaches a certain resistance. The MCU (140) may further comprise a wireless transceiver component operatively coupled to the one or more processing modules, configured to wirelessly couple the MCU (140) to the external sources.

In some embodiments, the one or more external sources may comprise one or more computing devices. In some embodiments, the computing devices may comprise a personal computing device, a portable computing device, a cloud computing device, or a combination thereof. In some embodiments, the alerts, the temperature measurement, or a combination thereof may be displayed by the one or more computing devices on one or more display components through a software application. In some embodiments, the alerts, the temperature measurement, or a combination thereof may be stored in one or more memory components of the one or more computing devices.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. An energy-efficient battery-operated temperature sensor system (100) comprising a temperature sensor (110) having an off mode, a low-power mode, and a high-power mode, wherein the temperature sensor (110) in the low-power mode is configured to sense when an environmental temperature reaches a temperature threshold, wherein the temperature sensor (110) in the high-power mode is configured to measure the environmental temperature in real-time, wherein, when the environmental temperature reaches the temperature threshold, the temperature sensor (110) is shifted into the high-power mode.

2. The system (100) of claim 1 further comprising a battery (120) operatively coupled to the temperature sensor (110).

3. The system (100) of claim 2, wherein the temperature sensor (110) is configured to consume less than or equal to an average discharge current of the battery (120).

4. The system (100) of claim 2 further comprising a negative temperature coefficient (NTC) thermistor (130) operatively coupled to the battery (120) and the temperature sensor (110), having a resistance inversely proportional to temperature, configured to control power delivered from the battery (120) to the temperature sensor (110) such that the NTC thermistor (130) shifts the temperature sensor (110) from the off mode to the low-power mode when the environmental temperature approaches the temperature threshold.

5. The system (100) of claim 2 further comprising a microcontroller unit (MCU) (140) operatively coupled to the battery (120) and the temperature sensor (110) configured to shift the temperature sensor (110) from the low-power mode to the high-power mode when the environmental temperature reaches the temperature threshold.

6. The system (100) of claim 5, wherein the MCU (140) is further configured to transmit an alert to an external source when the temperature sensor (110) detects that the environmental temperature reaches the temperature threshold.

7. The system (100) of claim 1, wherein the temperature threshold is 0 degrees Celsius.

8. The system (100) of claim 1, wherein the temperature threshold is 0 to 10 degrees Celsius.

9. An energy-efficient battery-operated temperature sensor system (100) comprising:
a. a battery (120);
b. a temperature sensor (110) operatively coupled to the battery (120), having an off mode, a low-power mode, and a high-power mode, wherein the temperature sensor (110) in the low-power mode is configured to sense when an environmental temperature reaches a temperature threshold, wherein the temperature sensor (110) in the high-power mode is configured to measure the environmental temperature in real-time;
c. a negative temperature coefficient (NTC) thermistor (130) operatively coupled to the battery (120) and the temperature sensor (110), having a resistance inversely proportional to temperature, configured to control power delivered from the battery (120) to the temperature sensor (110) such that the NTC thermistor (130) shifts the temperature sensor (110) from the off mode to the low-power mode when the environmental temperature approaches the temperature threshold; and
d. a microcontroller unit (MCU) (140) operatively coupled to the battery (120) and the temperature sensor (110), configured to shift the temperature sensor (110) into the high-power mode when the environmental temperature reaches the temperature threshold.

10. The system (100) of claim 9, wherein the temperature sensor (110) is configured to consume less than or equal to an average discharge current of the battery (120).

11. The system (100) of claim 9, wherein the MCU (140) is further configured to transmit an alert to an external source when the temperature sensor (110) detects that the environmental temperature reaches the temperature threshold.

12. The system (100) of claim 9, wherein the temperature threshold is 0 degrees Celsius.

13. The system (100) of claim 9, wherein the temperature threshold is 0 to 10 degrees Celsius.

14. A method for maximizing energy efficiency of a battery-operated temperature sensor system (100) comprising:
a. providing the system (100) comprising:
i. a battery (120);
ii. a temperature sensor (110) operatively coupled to the battery (120), having an off mode, a low-power mode, and a high-power mode;
iii. a negative temperature coefficient (NTC) thermistor (130) operatively coupled to the battery (120) and the temperature sensor (110), having a resistance inversely proportional to temperature; and
iv. a microcontroller unit (MCU) (140) operatively coupled to the battery (120) and the temperature sensor (110);
b. detecting, by the NTC thermistor (130), when the environmental temperature approaches the temperature threshold;
c. directing, by the NTC thermistor (130), power from the battery to the temperature sensor (110) such that the temperature sensor (110) is shifted into the low-power mode;
d. detecting, by the temperature sensor (110) in the low-power mode, when the environmental temperature reaches the temperature threshold;
e. directing, by the MCU (140), power from the battery to the temperature sensor (110) such that the temperature sensor (110) is shifted into the high-power mode; and
f. measuring, by the temperature sensor (110) in the high-power mode, the environmental temperature in real-time.

15. The method of claim 14, wherein the temperature sensor (110) is configured to consume less than or equal to an average discharge current of the battery (120).

16. The method of claim 14 further comprising transmitting, by the MCU (140), an alert to an external source when the temperature sensor (110) detects that the environmental temperature reaches the temperature threshold.

17. The method of claim 14, wherein the temperature threshold is 0 degrees Celsius.

18. The method of claim 14, wherein the temperature threshold is 0 to 10 degrees Celsius.
